(19) United States
(12) Patent Application Publication
(10) Pub. No.: US 2025/0341686 A1
(43) Pub. Date: Nov. 6, 2025

(54) TSV-ENABLED HYBRID SILICON PHOTONICS-ON-GLASS PACKAGE

(71) Applicant: Cisco Technology, Inc., San Jose, CA (US)

(72) Inventors: Ravi S. TUMMIDI, Breinigsville, PA (US); Hiren D. THACKER, San Diego, CA (US); Norbert SCHLEPPLE, Macungie, PA (US)

(21) Appl. No.: 18/653,708

(22) Filed: May 2, 2024

(51) Int. Cl. G02B 6/42

(52) U.S. Cl. CPC G02B 6/4259; G02B 6/4204; G02B 6/4243

(57) ABSTRACT

An electro-optical device is disclosed. The device includes a glass substrate having a plurality of through-glass vias. The device also includes a photonic integrated circuit hybrid bonded to the glass substrate by way of a metal-to-metal, oxide-to-oxide hybrid bond. The PIC has a plurality of through-silicon vias that are coupled with the through-glass vias. The device also includes an electronic integrated circuit coupled with the photonic integrated circuit. A method of assembling a device, or a plurality of devices, is also disclosed.

### TECHNICAL FIELD

Embodiments presented in this disclosure generally relate to a device equipped with a hybrid silicon photonics-on-glass package, with the silicon photonics being enabled with Through-Silicon Vias (TSVs). Embodiments presented in this disclosure also relate to assembly of such devices.

### BACKGROUND

Scaling silicon photonic packages to support faster data transmission rates has proven challenging. Achieving tighter electronic-photonic integration for enhanced signal integrity and power delivery while maintaining the mechanical and/or structural viability of such packages has proven particularly challenging.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A is a schematic side view of a device according to one example embodiment of the present disclosure.

FIG. 1B is a close-up view of a photonic integrated circuit according to one example embodiment of the present disclosure.

FIG. 2A is a flow diagram for a method of assembling a device according to one example embodiment of the present disclosure.

FIG. 2B shows a device being assembled according to the method set forth in FIG. 2A.

FIG. 3 is a schematic side view of a device according to another example embodiment of the present disclosure.

FIG. 4A is a schematic side view of a device according to yet another example embodiment of the present disclosure, with a fiber array unit passively optically coupled with a waveguide embedded within a glass substrate of the device.

FIG. 4B is a close-up side view of a fiber array unit actively optically coupled with a waveguide embedded within a glass substrate of a device.

FIG. 5A is a schematic side view of a device according to a further example embodiment of the present disclosure, with multiplexer and/or demultiplexer features embedded within a glass substrate of the device.

FIG. 5B is a close-up side view of a fiber array unit actively optically coupled with a waveguide embedded within a glass substrate of a device.

FIG. 6A is a schematic side view of a device according to another example embodiment of the present disclosure.

FIG. 6B is a close-up side view of a fiber array unit actively optically coupled with a waveguide embedded within a glass substrate of a device.

FIG. 7 is a schematic top plan view of an apparatus having a plurality of devices according to one example embodiment of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a device. The device includes a glass substrate having a plurality of through-glass vias (TGVs). The device also has a photonic integrated circuit (PIC) hybrid bonded to the glass substrate by way of a metal-to-metal, oxide-to-oxide hybrid bond. The PIC has a plurality of through-silicon vias (TSVs) that are coupled with the TGVs. Further, the device includes an electronic integrated circuit (EIC) coupled with the PIC.

Another embodiment presented in this disclosure is a method. The method includes hybrid bonding a plurality of photonic integrated circuits (PICs) to a glass substrate wafer, the plurality of PICs each having through-silicon vias (TSVs) and the glass substrate wafer having a plurality of through-glass vias (TGVs) coupled with the TSVs of the plurality of PICs when the PICs are hybrid bonded to the glass substrate wafer. The method also includes attaching a plurality of electronic integrated circuits (EICs) to respective ones of the plurality of PICs. The method further includes attaching a plurality of light sources to respective ones of the plurality of PICs. In addition, the method includes performing wafer singulation to create respective electro-optical packages, with each electro-optical package including a glass substrate formed from the glass substrate wafer, at least one of the plurality of PICs, at least one of the plurality of EICs, and at least one of the plurality of light sources. In performing the wafer singulation, at least one electro-optical package of the plurality of electro-optical packages is diced through the glass substrate and a PIC to create an optical interface of the PIC that is coplanar with a diced edge of the glass substrate.

A further embodiment presented in this disclosure is an apparatus. The apparatus includes a glass substrate having a plurality of through-glass vias (TGVs), an integrated circuit (IC) connected to the glass substrate, and at least one device coupled with the IC. The device includes a photonic integrated circuit (PIC) hybrid bonded to the glass substrate and having a plurality of through-silicon vias (TSVs) coupled with the TGVs. The device also has an EIC coupled with the PIC.

### EXAMPLE EMBODIMENTS

Embodiments herein disclose a device equipped with a hybrid silicon photonics-on-glass substrate, with the silicon photonics being enabled with Through-Silicon Vias (TSVs). Methods of assembling such devices are also disclosed.

In one example aspect, a device can include a relatively thin Photonic Integrated Circuit (PIC) having a photonic layer and a silicon handle. The PIC can include TSVs that extend through the silicon handle and provide a pathway for electrical signals to travel between the photonic layer and a glass substrate to which the PIC is hybrid bonded. The PIC can be bonded to the glass substrate using a metal-to-metal, oxide-to-oxide hybrid bond (e.g., a copper-to-copper, oxide-to-oxide hybrid bond), which creates a rigid structure that helps to flatten and support the relatively thin PIC (the PIC being relatively thin compared to the glass substrate as well as to conventional PICs that do not include TSVs). The glass substrate can include copper metallization for high and low speed signal transmission and Through-Glass Vias (TGVs) extending between top and bottom redistribution layers. The TGVs can be coupled with the TSVs, e.g., through electrically conductive pathways at the hybrid bond between the PIC and the glass substrate. The TGVs can carry signal/power/ground to the side of the glass substrate opposite the PIC. The device can also include an Electronic Integrated Circuit (EIC) stacked on the PIC and electrically coupled thereto, as well as one or more fibers optically coupled with the PIC. The EIC can be hybrid bonded to the PIC (e.g., using a metal-to-metal, oxide-to-oxide hybrid bond) or can be attached thereto by other techniques. Such a device (or many devices) can be assembled at the wafer level. In some aspects, during wafer singulation, a PIC hybrid bonded to a glass substrate can be diced so that a diced side edge of the PIC and a diced side edge of the glass substrate are formed concurrently or in a single dice movement (e.g., in a single laser pass or a single dicing blade pass), rendering diced coplanar edges. These diced coplanar side edges can provide an optical interface for an edge-coupled Fiber Array Unit (FAU), for example.

The device and methods of assembly disclosed herein can provide one or more advantages, benefits, and/or technical effects. For instance, the metal-to-metal, oxide-to-oxide hybrid bond between the PIC and the glass substrate can enable optical signals to be transferred into the glass substrate and can provide tight tolerance and flatness control for enhanced optical input/output control of the device, which addresses flatness/warpage performance challenges of a silicon photonic die with TSVs. Further, the use of the glass substrate can more closely match the coefficients of Thermal Expansion (CTE) of the silicon handle of the PIC and the substrate, compared to using a conventional organic substrate. This enhanced CTE matching can enable opportunities for edge coupling and can eliminate or reduce the need for the PIC to overhang the substrate to provide clearance for an FAU to couple to the PIC. The hybrid bonding aspect can also allow for shorter electrical paths, lower parasitics, and lower electrical power needed for the device, which may allow for the device to meet faster data transmission rates, such as greater than 100 Gbps per λ.

In addition, the device can be assembled using a concurrent and coplanar dicing scheme, which simultaneously creates an optical coupling facet and provides a large mechanical contact area for FAU edge attachment. Further, passive optical elements can be offloaded to the glass substrate, such as optical waveguides, wavelength and/or polarization Multiplexers/Demultiplexers (MUX/DEMUX), spot size converters, some combination thereof, etc. In addition, passive fiber attach/align structures can be included in the glass substrate, such as fiber V-grooves or U-grooves. Moreover, in some aspects, the glass substrate can have non-planar topologies, such as cavities, that enable direct butt coupling between a PIC edge coupler and a waveguide written into the glass substrate. In yet further aspects, an apparatus having multiple EICs and/or PICs and/or other integrated circuits can be bonded to the same glass substrate, creating a self-contained CTE-matched Multi-Chip-Module (MCM) independent of an end user's application. Further, the device can provide tighter bump pitch (e.g., <<80 μm) between the EIC and the PIC when the EIC is hybrid bonded or thermal conductive bonded to the PIC. The device can also be assembled by leveraging wafer-level assembly processes and the advantages thereof, such as wafer level testing, known good Chip-on-Chip (CoC) determination for further packaging, etc. The device and methods of assembly can have other advantages, benefits, and/or technical effects besides those noted herein.

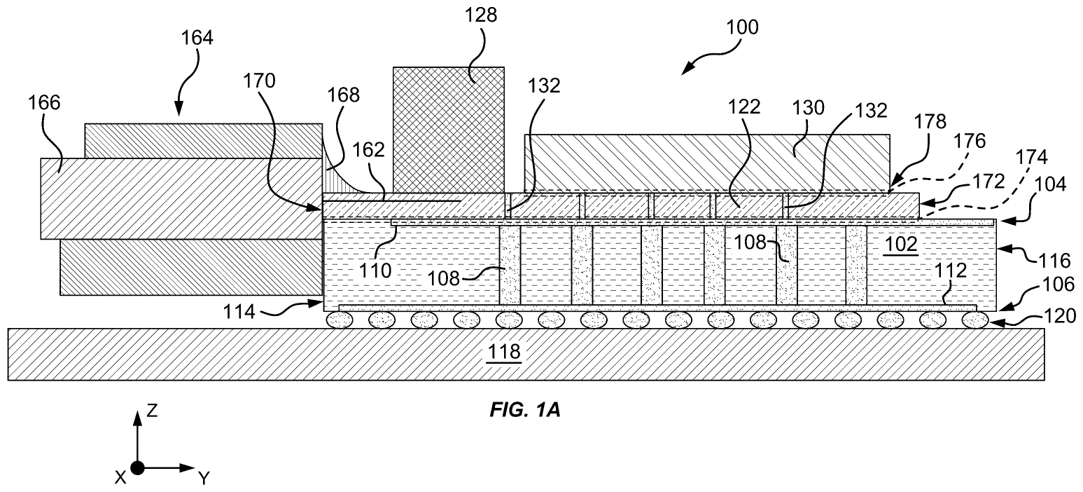

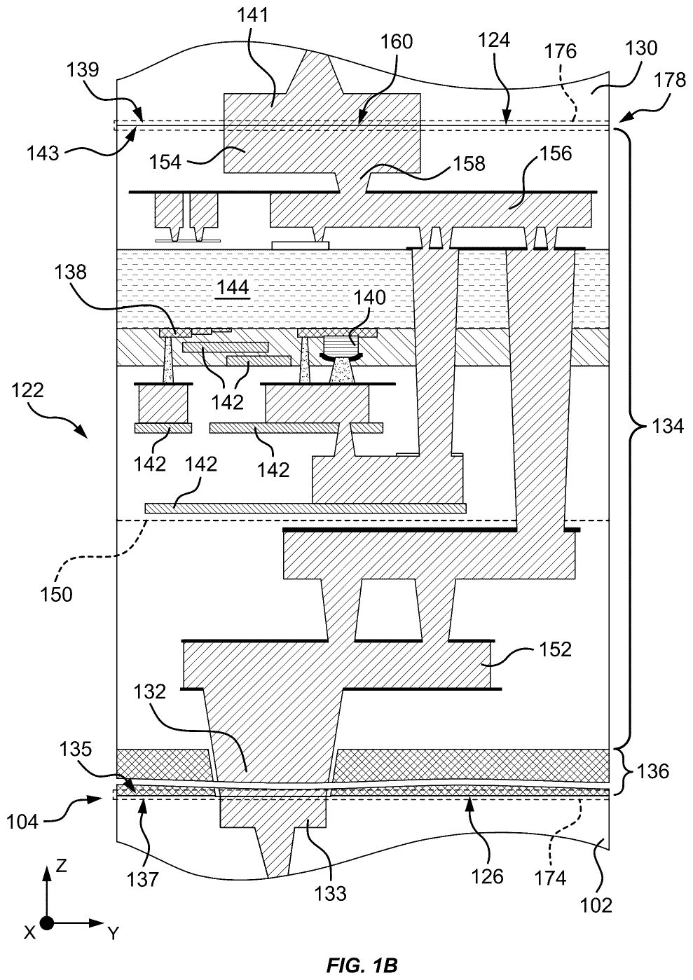

Referring now to the drawings, FIG. 1A is a schematic side view of a device 100, according to one example embodiment of the present disclosure. For the depicted embodiment of FIG. 1A, the device 100 is a silicon photonic LoCoCoS (LaMP-on-Chip-on-Chip-on-Substrate). For reference, the device 100 defines a first direction X, a second direction Y, and a third direction Z, which are mutually perpendicular to one another and form an orthogonal direction system. The first direction X can be a transverse direction, the second direction Y can be a lateral direction, and the third direction Z can be a vertical direction, for example.

The device 100 includes a glass substrate 102 having a top side 104 and a bottom side 106 that define a thickness of the glass substrate 102 along the third direction Z. The glass substrate 102 has copper metallization for high and low speed signal transmission and power delivery. The glass substrate 102 has a plurality of Through-Glass Vias, or TGVs 108, that carry signals, power, and/or ground, e.g., between a top redistribution layer 110 and a bottom redistribution layer 112. The TGVs 108 can be formed of copper, for example. The glass substrate 102 also has a first side edge 114 and a second side edge 116 that define a length of the glass substrate 102 along the second direction Y. The bottom side 106 of the glass substrate 102 can be coupled with a Printed Circuit Board, or PCB 118. Ball Grid Arrays, or BGAs 120, can be used to mount the glass substrate 102 onto the PCB 118.

The device 100 also includes a Photonic Integrated Circuit (PIC), or PIC 122. The PIC 122 has a stackable-interface surface 124 (FIG. 1B) and a substrate-interface surface 126 (FIG. 1B) that define a thickness of the PIC 122 along the third direction Z. The thickness of the PIC 122 can be one hundred twenty (120) microns or less, for example. A light source 128 and a chip, such as an Electronic Integrated Circuit or EIC 130, can be stacked on the PIC 122, or rather, coupled with the stackable-interface surface 124 of the PIC 122. The light source 128, or Laser MicroPackage (LaMP), may be attached to the PIC 122 to inject optical power into the device 100. The EIC 130 can include, for example, a driver, Rx transimpedance amplifier circuits, and other components. Further, the PIC 122 includes a plurality of Through-Silicon Vias, or TSVs 132, that carry signals, power, and/or ground. The introduction of the TSVs 132 into the PIC 122 can enable tighter electronic-photonic integration between the EIC 130, the PIC 122, and the glass substrate 102, which can enhance signal integrity and power delivery of the device 100.

With reference now to FIG. 1B, FIG. 1B is a close-up view of the PIC 122, which is not drawn to scale. As shown, the PIC 122 is arranged as a Silicon-On-Insulator (SOI) device, or rather, a silicon photonics integration platform. The PIC 122 has a silicon photonic layer 134 and a silicon handle 136 (or silicon substrate). In some embodiments, the silicon photonic layer 134 can be about twenty (20) microns and the silicon handle 136 can be about one hundred (100) microns, with the total thickness of the PIC 122 being about one hundred twenty (120) microns. As used herein, “about” or other terms of approximation means within five percent (5%) of a stated value. The silicon photonic layer 134 is an active layer and has, among other things, an optical modulator 138 (e.g., an integrated high speed Semiconductor-Insulator-Semi-conductor Capacitor modulator or SISCAP modulator), an optical detector 140 (e.g., a Germanium Photo Diode or GePD), silicon nitride waveguides 142, a buried insulation layer 144 (also referred to as buried oxide (BOX) layer), and a conductive pathway formed by interconnected metal layers and vias. The PIC 122 can define a wafer bond interface 150.

In FIG. 1B, one of the TSVs 132 is shown extending through the silicon handle 136 and connecting to a first metal layer 152 of PIC 122 arranged in the silicon photonic layer 134. The conductive pathway formed by the metal layers and vias can couple the TSV 132 with, among other components of the PIC 122, a metal pad 154 arranged at the stackable-interface surface 124 of the PIC 122 as illustrated in FIG. 1B. The metal pad 154 provides an electrical coupling interface, e.g., for the EIC and/or other chips to electrically couple with the PIC 122. The metal pad 154 can be connected with a second metal layer 156 of the conductive pathway by way of a metal via 158, which can be formed of copper, for example. In some embodiments, a contact surface 160 of the metal pad 154 is flush with the stackable-interface surface 124 or top edge of the PIC 122. Such an arrangement can facilitate hybrid bonding (e.g., a metal-to-metal, oxide-to-oxide hybrid bond) between the PIC 122 and the EIC 130, as will be explained further below.

With reference again to FIG. 1A, the PIC 122 also has a spot size convertor 162 (e.g., a prong coupler) that optically couples a Fiber Array Unit, or FAU 164, with the PIC 122. The FAU 164 can include one or more optical fibers 166 (e.g., single mode optical fibers) optically coupled with the spot size convertor 162 as shown in FIG. 1A. In at least some embodiments, an index matching epoxy 168 can couple the FAU 164 with the PIC 122 and the glass substrate 102. The PIC 122 has a first side edge 170 and a second side edge 172 that define a length of the PIC 122 along the second direction Y. The first side edge 170 of the PIC 122, which provides an optical interface or optical facet between the FAU 164 and the PIC 122, can be substantially coplanar with the first side edge 114 of the glass substrate 102. That is, the first side edge 170 of the PIC 122 can be arranged in a same or substantially a same plane as the first side edge 114 of the glass substrate 102, wherein the plane is orthogonal to the second direction Y. As will be explained further below, the PIC 122 and the glass substrate 102 can be diced, with the PIC 122 arranged on the glass substrate 102, so that the first side edge 170 of the PIC 122 and the first side edge 114 of the glass substrate 102 are formed concurrently or in a single dice movement (e.g., in a single laser pass or a dicing blade pass), rendering diced coplanar edges.

For the depicted embodiment of FIG. 1A, the PIC 122 is hybrid bonded to the glass substrate 102. That is, the PIC 122 and the glass substrate 102 are bonded by way of a hybrid bond 174. In at least some embodiments, the hybrid bond 174 can be a metal-to-metal, oxide-to-oxide hybrid bond, such as a copper-to-copper, oxide-to-oxide hybrid bond. At the substrate-interface surface 126 of the PIC 122, the PIC 122 can include an oxide layer and a plurality of metal contacts spaced from one another. Similarly, at the top side 104 of the glass substrate 102, or rather at the PIC-interface surface of the glass substrate 102, the glass substrate 102 can include an oxide layer and a plurality of metal contacts spaced from one another. During hybrid bonding, a metal-to-metal bond (e.g., a copper-to-copper bond) can be formed between the metal contacts of the glass substrate 102 and the metal contacts of the PIC 122, and an oxide-to-oxide bond can be formed between the oxide layer of the glass substrate 102 and the oxide layer of the PIC 122. The oxide layers can be formed of silicon dioxide, for example. Such a hybrid bond can provide optical coupling between the PIC 122 and the glass substrate 102 and also enables the glass substrate 102 to mechanically support the PIC 122, which can be constructed relatively thin (e.g., less than or equal to 120 microns) to reveal the TSVs 132. Further, such a hybrid bond can enable tight tolerance and flatness control for enhancing optical input/output of the device 100.

In some embodiments, at least one metal contact of the PIC 122 is formed by an end of one of the TSVs 132. In other embodiments, at least one metal contact of the PIC 122 is formed by a metal pad connected to one of the TSVs 132 by way of one or more copper layers and/or copper vias in a redistribution layer of the PIC 122. In some further embodiments, at least one metal contact of the glass substrate 102 is formed by an end of one of the TGVs 108. In yet other embodiments, at least one metal contact of the glass substrate 102 is formed by a metal pad connected to one of the TGVs 108 by way of one or more copper layers and/or copper vias in the top redistribution layer 110. In FIG. 1A, the metal contacts of the PIC 122 are ends of the TSVs 132 and the metal contacts of the glass substrate 102 are metal pads of the top redistribution layer 110. Accordingly, in this example, the ends of the TSVs 132 are bonded to the metal pads of the top redistribution layer 110, while an oxide layer of the glass substrate 102 is bonded to an oxide layer of the PIC 122. FIG. 1B shows a close-up view of one of the TSVs 132 in bonded engagement with one of the metal contacts 133 of the glass substrate 102 and an oxide layer 135 of the PIC 122 in bonded engagement with an oxide layer 137 of the glass substrate 102, on both sides of the metal-to-metal bond. The bonding of these components can result in the hybrid bond 174 at the interface of the glass substrate 102 and the PIC 122.

In some embodiments, up to ninety percent (90%) of the substrate-interface surface 126 (FIG. 1B) of the PIC 122 can be hybrid bonded to the glass substrate 102 by the hybrid bond 174 (e.g. up to ninety percent (90%) of the length of the PIC 122 along the second direction Y). In other embodiments, an entirety of the substrate-interface surface 126 is supported and hybrid bonded to the glass substrate 102 by the hybrid bond 174. Such embodiments can ensure that the PIC 122 is mechanically supported by the glass substrate 102 in a satisfactory manner. The hybrid bond 174 and arrangement of the components can allow for planar-to-planar or face-to-face bonding of the glass substrate 102 and the PIC 122, which can reduce the overall packaging of the device 100.

The EIC 130 can be coupled to the PIC 122 using a number of different techniques, including a copper pillar flip chip process, a microbump flip chip process, a thermocompression bonding process, or a hybrid bond process. In FIG. 1A, the PIC 122 is hybrid bonded to the EIC 130. That is, the PIC 122 and the EIC 130 are bonded by way of a hybrid bond 176. The EIC 130 can be hybrid bonded to the PIC 122 by way of a metal-to-metal, oxide-to-oxide hybrid bond, such as a copper-to-copper, oxide-to-oxide hybrid bond. At the stackable-interface surface 124 of the PIC 122, the PIC 122 can include an oxide layer and a plurality of metal contacts. For instance, at least one of the metal contacts of the PIC 122 can be the metal pad 154 shown in FIG. 1B. The metal pad 154 is advantageously arranged for metal-to-metal bonding (e.g., copper-to-copper bonding), particularly because its contact surface 160 is flush with the stackable-interface surface 124 of the PIC 122. As shown in FIG. 1B, at an interface side 178 of the EIC 130, the EIC 130 can include an oxide layer 139 and a plurality of metal contacts 141 (only one shown in FIG. 1B). During hybrid bonding, a metal-to-metal bond (e.g., a copper-to-copper bond) can be formed between the metal contacts of the PIC 122 and the metal contacts of the EIC 130, and an oxide-to-oxide bond can be formed between the oxide layer of the PIC 122 and the oxide layer of the EIC 130. FIG. 1B shows a close-up view of one of the metal contacts 141 of the EIC 130 in bonded engagement with one of the metal pads 154 of the PIC 122 and an oxide layer 143 of the PIC 122 in bonded engagement with the oxide layer 139 of the EIC 130, on both sides of the metal-to-metal bond. Such a hybrid bond can provide coupling between the PIC 122 and the EIC 130 and can reduce device parasitics by reducing bond pad area and interconnect (copper pillar) length.

Accordingly, for depicted embodiment of FIG. 1A, the relatively thin PIC 122 with TSVs 132 (the PIC 122 is thinned to reveal the TSVs 132) is bonded to the glass substrate 102 using a metal-to-metal, oxide-to-oxide hybrid bond (e.g., using a copper-to-copper, oxide-to-oxide hybrid bond), which creates a rigid structure flattening the thinned PIC 122. The rigid structure of the glass substrate 102 helps avoid warpage of the relatively thin PIC 122 and provides a rigid surface for edge coupling of the FAU 164. The glass substrate 102 includes copper metallization for high and low speed signal transmission, and also includes TGVs 108. The optical coupling interface of the PIC 122 can be created by mechanical dicing, which provides satisfactory edge coupling characteristics.

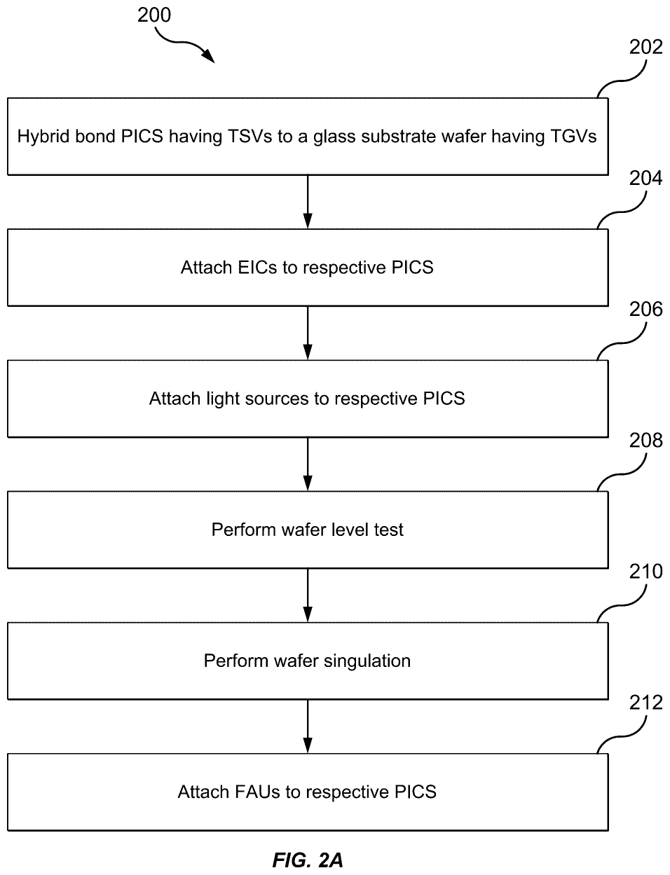

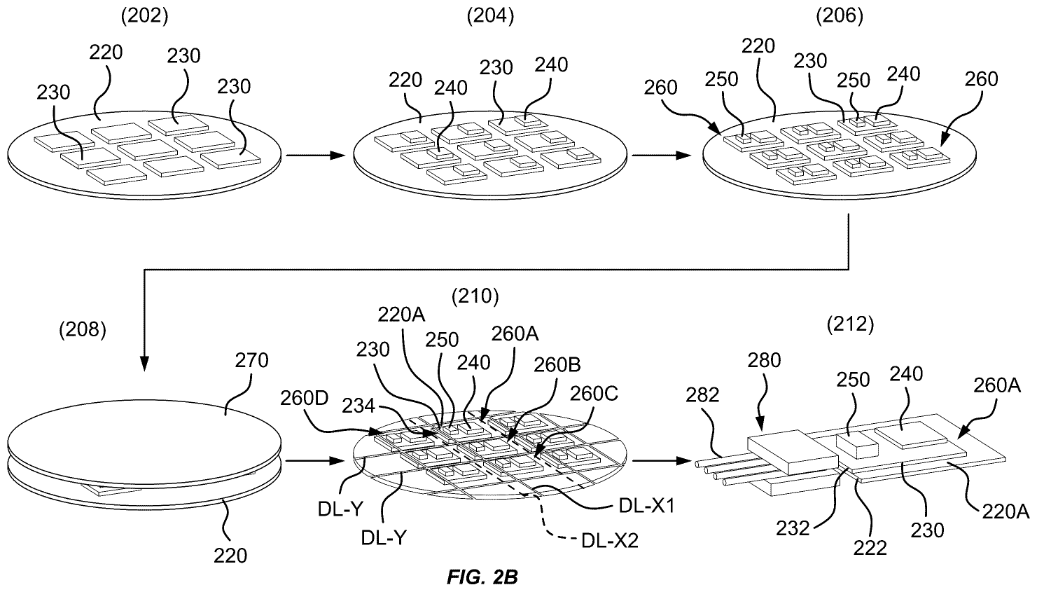

With reference now to FIGS. 2A and 2B, FIG. 2A is a flow diagram for a method 200 of assembling a device (or many devices) according to one example embodiment of the present disclosure. For instance, the method 200 can be used to assemble the device 100 of FIG. 1A, for example. FIG. 2B shows a plurality of devices being assembled according to the method 200 set forth in FIG. 2A.

At 202, the method 200 can include hybrid bonding a plurality of PICs to a glass substrate wafer, wherein the plurality of PICs each have Through-Silicon Vias (TSVs) and the glass substrate wafer has a plurality of through-glass vias (TGVs). For instance, as shown in FIG. 2B at 202, a plurality of PICs 230 (or PIC dies) each having TSVs are hybrid bonded to a glass substrate wafer 220, e.g., with a metal-to-metal, oxide-to-oxide hybrid bond. The PICs 230 can be arranged in an array of rows and columns as illustrated in FIG. 2B. In some implementations, the glass substrate wafer 220 can include sets, with each set including TGVs and redistribution layers, organized in a manner to correspond to the mounting locations of the PICs 230. In this way, when singulated, the PICs 230 and their corresponding sets can each be arranged as in FIG. 1A. In addition, the TSVs of the PICs 230 as well as the TGVs and redistribution layers of the glass substrate wafer 220 can be formed prior to the hybrid bonding process at 202.

At 204, the method 200 can include attaching EICs to respective ones of the plurality of PICs. For instance, as shown in FIG. 2B at 204, EICs 240 are attached or coupled with respective ones of the PICs 230. In some implementations, in attaching the EICs 240 to the respective PICs 230, the EICs 240 are hybrid bonded to their respective PICs 230, e.g., via metal-to-metal, oxide-to-oxide hybrid bonds. In such implementations, at least one of the PICs 230 can have a metal pad at a stackable-interface surface of the PIC, e.g., as shown in FIG. 1B. The metal pad can be bonded to a corresponding metal contact of the EIC. In other implementations, the EICs 240 can be attached to their respective PICs 230 using a copper pillar flip chip process, a microbump flip chip technique, or a thermocompression bonding process. In some implementations, some combination of these techniques can be used, including hybrid bonding in combination with one or more of the other noted techniques.

At 206, the method 200 can include attaching light sources to respective ones of the plurality of PICs. For instance, as shown in FIG. 2B at 206, light sources 250 are attached or coupled with respective ones of the PICs 230 at the wafer level. The light sources 250 can be attached or coupled with their respective PICs 230 using any suitable technique.

At 208, the method 200 can include performing, prior to wafer singulation at 210, a wafer level test using a test card to test which electro-optical packages satisfy an operational threshold. For instance, a plurality of electro-optical packages 260 can be formed, e.g., by implementing 202, 204, and 206 of the method 200, with each one of the electro-optical packages 260 including one of the plurality of PICs 230, one of the plurality of EICs 240, one of the plurality of light sources 250, and a portion of the glass substrate wafer 220 (e.g., a portion upon which electro-optical elements are mounted). In FIG. 2B, nine (9) electro-optical packages 260 are formed at 206, and these electro-optical packages 260 are tested at 208. In other implementations, more or less than nine (9) electro-optical packages 260 can be formed. As illustrated in FIG. 2B, a test card 270 can be placed on top of electro-optical packages 260 to establish electrical contact with various elements or circuits. The test card 270 can be used to test which ones of the electro-optical packages 260 are “good packages” by satisfying an operational threshold, such as which ones produce a predetermined electric current, a predetermined voltage, etc. In addition, optical testing can be performed, e.g., by coupling light in or out of the wafer. In this way, it may be determined which ones of the electro-optical packages 260 satisfy an operational threshold, e.g., a predetermined optical intensity.

In some example embodiments, the testing at 208 can include verifying electrical continuity between the EICs 240, the PICs 230 and the glass substrate 220 using daisy chain circuits encompassing these components. Further tests can include electro-optic tests in which light is coupled into the CoCoS using gratings, electrical probing of pads is performed to collect and launch electrical signals, and light is collected again using the gratings. A subset of these can also be performed.

At 210, the method 200 can include performing wafer singulation to create respective electro-optical packages. For instance, as shown in FIG. 2B at 210, dicing can be used to singulate the electro-optical packages 260 according to dicing lines. Some of the dicing lines DL-X1, DLX-2 are arranged along the first direction X while some of the dicing lines DL-Y are arranged along the second direction Y. In this regard, performing the singulation process can separate the electro-optical packages 260 into individual packages. Dicing can be done by a number of suitable techniques, such as by laser dicing or some other mechanical dicing technique.

In some implementations, in performing the singulation, at least one electro-optical package of the plurality of electro-optical packages 260 is diced through the glass substrate and the PIC thereof to create a diced edge of the PIC that is coplanar with a diced edge of the glass substrate, wherein the diced edge of the PIC functions as an optical interface of the PIC (e.g., the face to which an FAU can be attached). For instance, as depicted in FIG. 2B at 210, a first dicing line DL-X1 extending along the first direction X is aligned so that, when dicing is performed, the PIC 230 and the glass substrate 220A of a first electro-optical package 260A are diced concurrently to form the first side edge 232 of the PIC 230 and the first side edge 222 of the glass substrate 220A to be coplanar (see FIG. 2B at 212, which shows the concurrently diced and coplanar first side edges 232, 222). Further, in some implementations, a second closely spaced dicing may be performed to remove a PIC remnant 234 from an adjacent electro-optical package 260D, e.g., so that the PIC remnant 234 is not a part of the adjacent electro-optical package 260D. The PIC remnant 234 can be removed via a secondary dicing line DL-X2 that extends along the first direction X.

In some implementations, in performing the wafer singulation at 210, at least two electro-optical packages of the plurality of electro-optical packages 260 are diced through their respective glass substrates and their respective PICs concurrently. For instance, in FIG. 2B, the first electro-optical package 260A, a second electro-optical package 260B, and a third electro-optical package 260C are arranged in a row. The first dicing line DL-X1 is shown aligned so that, when dicing is performed along the first dicing line DL-X1, the PIC 230 and the glass substrate 220A of the first electro-optical package 260A, the PIC and the glass substrate of the second electro-optical package 260B, and the PIC and the glass substrate of the third electro-optical package 260C are all diced concurrently, e.g., with a single pass of a dicing blade. When diced, the first side edge of the PIC 230 and the first side edge 222 of the glass substrate 220A of the first electro-optical package 260A are coplanar, the first side edge of the PIC and the first side edge of the glass substrate of the second electro-optical package 260B are coplanar, and the first side edge of the PIC and the first side edge of the glass substrate of the third electro-optical package 260C are coplanar. It will be appreciated that the other dicing lines arranged along the first direction X can similarly concurrently dice the respective PICs and glass substrates of the electro-optical packages 260 of the other rows.

At 212, the method 200 can include coupling a fiber array unit to the optical interface of the PIC. For instance, as shown in FIG. 2B at 212, an FAU 280 having a plurality of fibers 282 is coupled with the first side edge 232 of the PIC 230 and the first side edge 222 of the glass substrate 220A of the first electro-optical package 260A. In some implementations, an FAU can be attached to each electro-optical package determined to satisfy the operational threshold at 208. In this way, an FAU can be attached to each “good package” of the electro-optical packages 260. Accordingly, testing the electro-optical packages 260 at the wafer level at 208 can facilitate production efficiency, eliminating the need to test each package one-by-one by attaching FAUs thereto.

Once the electro-optical packages are coupled with their respective FAUs at 212, the electro-optical packages 260 can be mounted on a PCB, e.g., as shown in FIG. 1A, and implemented in an application, such as a transceiver of a networking apparatus.

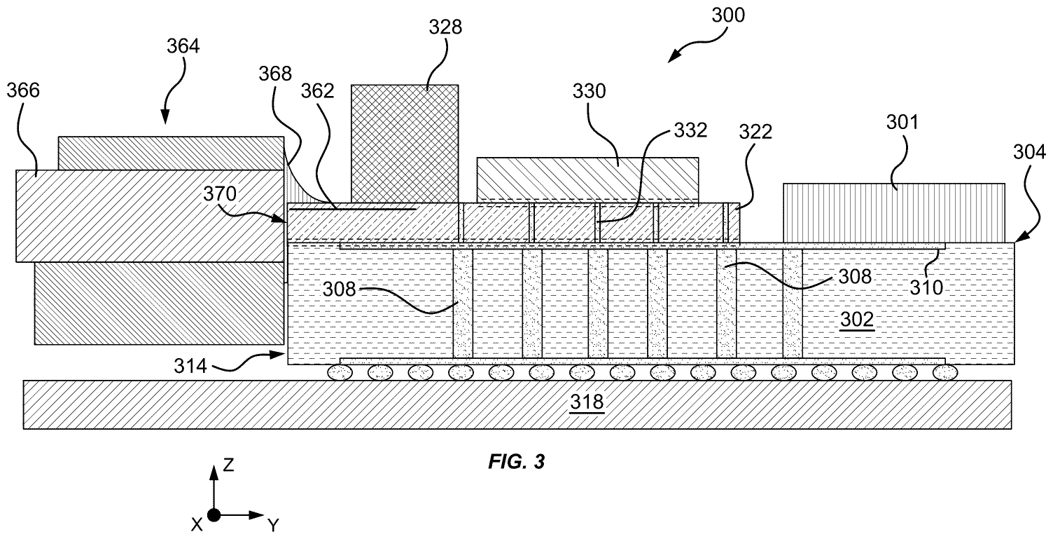

FIG. 3 is a schematic side view of a device 300 according to another example embodiment of the present disclosure. The device 300 of FIG. 3 is constructed in a similar manner as the device 100 of FIG. 1A (and can be assembled in a similar manner as well). Accordingly, similar numerals will be utilized to refer to like structures, except that 300 series numbers will be utilized to describe the device 300 of FIG. 3.

As shown in FIG. 3, the device 300 is arranged as a photonic Multi-Chip-Module (MCM) on glass substrate, or photonic MCM-on-glass substrate. As depicted, the device 300 includes a glass substrate 302 arranged on a PCB 318. The glass substrate 302 has TGVs 308. A PIC 322 having TSVs 332 is stacked on the glass substrate 302 and is hybrid bonded thereto, e.g., by way of a metal-to-metal, oxide-to-oxide hybrid bond. A light source 328 and an EIC 330 are stacked on the PIC 322. The EIC 330 can be hybrid bonded to the PIC 322, e.g., by way of a metal-to-metal, oxide-to-oxide hybrid bond). An FAU 364 is coupled with the PIC 322 and the glass substrate 302, e.g., by way of an index matching epoxy 368. The FAU 364 is actively optically coupled with the diced coplanar first side edges 314, 370 of the glass substrate 302 and the PIC 322. One or more fibers 366 of the FAU 364 are optically coupled with a spot size convertor 362 of the PIC 322.

The device 300 includes at least one additional chip attached to the glass substrate 302 (in addition to the PIC 322). For the depicted embodiment of FIG. 3, a second chip 301 (e.g., a Digital Signal Processing (DSP) chip) is “flip chip” attached or hybrid bonded to the glass substrate 302. Accordingly, the PIC 322 and the second chip 301 are coupled with the glass substrate 302. In this regard, the PIC 322 and the second chip 301 are arranged on a common glass substrate. In some embodiments, more than one chip besides the PIC 322 can be attached to the glass substrate 302, e.g., to the top side 304 thereof. In this regard, the device 300 is scalable. The second chip 301 can be electrically coupled with the glass substrate 302, and to other chips of the device 300, such as the PIC 322, the EIC 330, etc. The top redistribution layer 310 of the glass substrate 302 can be electrically coupled with the second chip 301. Electrically conductive pathways, provided in part by the TGVs 308 and TSVs 332, can enable communication between the chips of the device 300 (e.g., without the use or need of wirebonds).

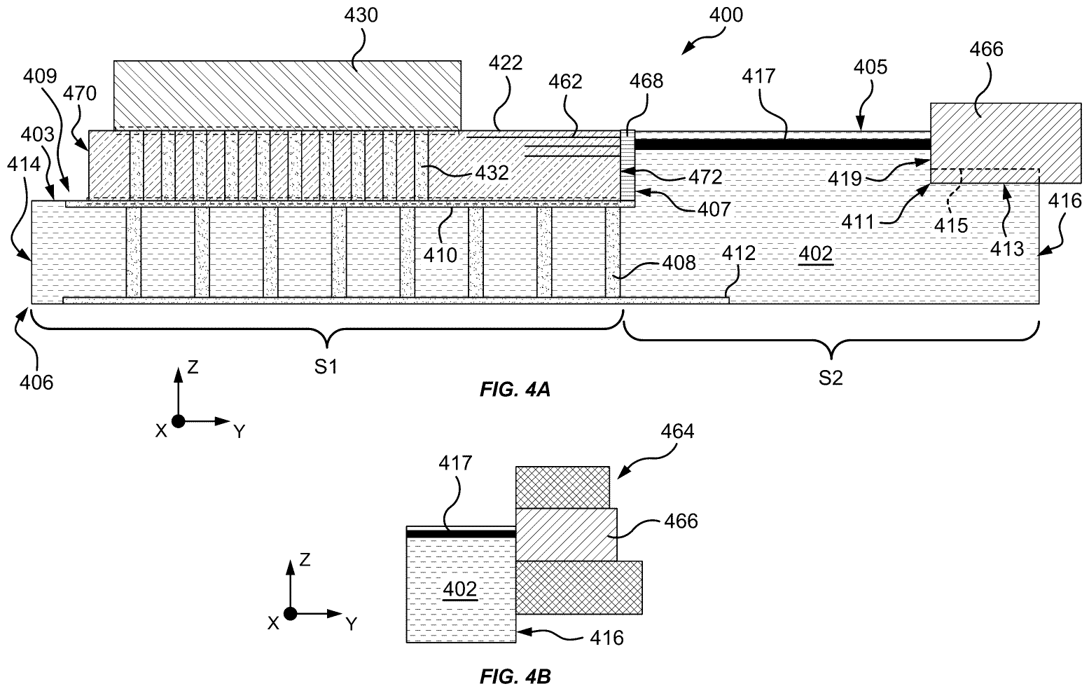

FIG. 4A is a schematic side view of a device 400 according to yet another example embodiment of the present disclosure. The device 400 of FIG. 4A includes some similar features as the device 100 of FIG. 1A. Accordingly, similar numerals will be utilized to refer to like structures, except that 400 series numbers will be utilized to describe the device 400 of FIG. 4A.

As shown in FIG. 4A, the device 400 includes a glass substrate 402 with a non-planar topology, or more particularly, a non-planar top side. Stated differently, the glass substrate 402 has varying height along the third direction Z, e.g., as viewed along the first direction X as in FIG. 4A. A first section S1 of the glass substrate 402 extends between a bottom side 406 and a platform seat 403 to define a thickness of the first section S1 along the third direction Z. A second section S2 of the glass substrate 402 extends between the bottom side 406 and a top surface 405 to define a thickness of the second section S2 along the third direction Z. The second section S2 is thicker than the first section along the third direction Z. The glass substrate 402 has a first side edge 414 and a second side edge 416 defining a length of the glass substrate 402 along the second direction Y. An optical edge 407 of the glass substrate 402 and the second side edge 416 define a length of the second section of the glass substrate 402 along the second direction Y.

In the first section S1, the glass substrate 402 includes metallization, top and bottom RDLs 410, 412, and TGVs 408 extending between and connecting the metal components of the top and bottom RDLs 410, 412. The glass substrate 402 defines a platform pocket 409 in which a PIC 422 is arranged. The platform pocket 409 is defined by the platform seat 403 and the optical edge 407 of the glass substrate 402. The PIC 422 is seated on the platform seat 403 of the glass substrate 402 and can be coupled with the optical edge 407 of the glass substrate 402 by way of an index matching epoxy 468. In some embodiments, the PIC 422 can be directly connected to the optical edge 407. The PIC 422 can be hybrid bonded to the platform seat 403 of the glass substrate 402, e.g., by way of a metal-to-metal, oxide-to-oxide hybrid bond.

The PIC 422 includes a first side edge 470 and a second side edge 472 defining a length of the PIC 422 along the second direction Y. At the second side edge 472, the PIC 422 includes a spot size convertor 462. The spot size convertor 462 extends from the second side edge 472 toward TSVs 432 of the PIC 422 along the second direction Y. An EIC 430 can be stacked on the PIC 422, and can be coupled with the PIC 422 via a hybrid bond, e.g., by way of a metal-to-metal, oxide-to-oxide hybrid bond or some other attachment technique.

Further, for the depicted embodiment of FIG. 4A, the glass substrate 402 defines a pocket 411 that enables direct attachment of one or more fibers 466 to the glass substrate 402. The pocket 411 can be etched into the glass substrate 402 and can include features that facilitate alignment and passive optical coupling. For instance, a pocket floor 413 of the glass substrate 402 can define one or more grooves 415 (e.g., U-grooves or V-grooves) in which the fibers 466 can be arranged and supported. Accordingly, the pocket 411 can facilitate passive optical coupling of the fibers 466 with a waveguide 417 embedded within the glass substrate 402. As illustrated, the waveguide 417, which can be a single mode fiber-matched waveguide, extends from a pocket edge 419 of the glass substrate 402 to the optical edge 407. In this regard, an optical signal can travel from the fibers 466, through the waveguide 417 and the index matching epoxy 468, and can be received by a spot size convertor 462 of the PIC 422, which can direct the optical signal within the PIC 422. Optical signals can also travel in the reverse direction. With the non-planar topology of the device 400 of FIG. 4A, direct butt coupling between the spot size convertor 462 of the PIC 422 and the waveguide 417 of the glass substrate 402 can be achieved.

In some alternative embodiments of the device 400, instead of the pocket 411 etched into the glass substrate 402 as shown in FIG. 4A, an FAU 464 can be actively optically coupled with the second side edge 416, or diced facet, of the glass substrate 402 as shown in FIG. 4B. The FAU 464 can be arranged so that one or more fibers 466 thereof can be aligned with the waveguide 417 of the glass substrate 402, e.g., in an edge coupled arrangement.

In some assembly implementations of the device 400, the waveguide 417 can be written post-PIC and post-EIC attachment to the glass substrate 402 using a femtosecond laser writing technique aided by precise alignment marks on the PIC 422 and the glass substrate 402. Such a technique can facilitate precise alignment of the waveguide 417 and the spot size convertor 462. With the PIC 422 hybrid bonded to the glass substrate 402, the waveguide 417 can be written to the glass substrate 402 to precisely align with the spot size convertor 462.

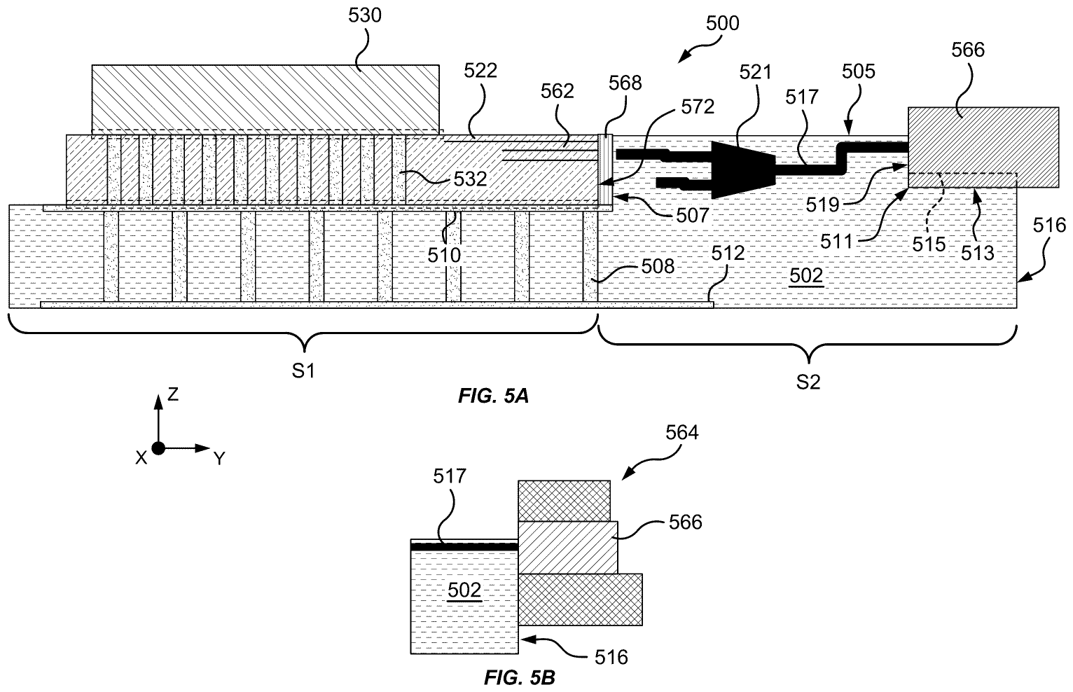

FIG. 5A is a schematic side view of a device 500 according to a further example embodiment of the present disclosure. The device 500 of FIG. 5A includes some similar features as the device 100 of FIG. 1A and of the device 400 of FIG. 4A. Accordingly, similar numerals will be utilized to refer to like structures, except that 500 series numbers will be utilized to describe the device 500 of FIG. 5A.

As shown in FIG. 5A, the device 500 includes a glass substrate 502. In a first section S1 of the device 500, the glass substrate 502 includes metallization, top and bottom RDLs 510, 512, and TGVs 508 extending between and connecting the metal components of the top and bottom RDLs 510, 512. A PIC 522 having TSVs 532 is stacked on the glass substrate 502. The PIC 522 can be coupled with the glass substrate 502 by way of a hybrid bond, e.g., by way of a metal-to-metal, oxide-to-oxide hybrid bond. An EIC 530 can be stacked on the PIC 522, and can be coupled with the PIC 522 by way of a hybrid bond, e.g., by way of a metal-to-metal, oxide-to-oxide hybrid bond or some other attachment technique.

In the device 500 of FIG. 5A, optical features are embedded within the glass substrate 502. The optical features can be written to the glass substrate 502, for example. In this example, the optical features are written to a second section S2 of the device 500, e.g., just below a top surface 505 thereof. Specifically, for the depicted embodiment of FIG. 5A, the device 500 includes a multiplexing device 521, which can include a multiplexer, demultiplexer, or both. Accordingly, multiplexing and/or demultiplexing functionality can be offloaded to and incorporated in the glass substrate 502. The multiplexing device 521 can be coupled with a waveguide 517 also embedded in the glass substrate 502 at one end and a spot size convertor 562 of the PIC 522 at its other end (by way of an index matching epoxy 568 arranged between a second side edge 572 of the PIC 522 and an optical edge 507 of the glass substrate 502). Generally, a multiplexer can be used to combine optical signals of various wavelengths into a single composite signal in a transmit direction while a demultiplexer can be used to separate a composite optical signal into individual wavelengths.

Further, as illustrated in FIG. 5A, the glass substrate 502 defines a pocket 511 that enables direct attachment of one or more fibers 566 to the glass substrate 502. The pocket 511 can be etched into the glass substrate 502 and can include features that facilitate alignment and passive optical coupling of the fibers 566 to the glass substrate 502. For instance, a pocket floor 513 of the glass substrate 502 can define one or more grooves 515 (e.g., U-grooves or V-grooves) in which the fibers 566 can be arranged and supported. Accordingly, the pocket 511 can facilitate passive optical edge coupling of the fibers 566 with the waveguide 517. The waveguide 517, which can be a single mode fiber-matched waveguide, extends from a pocket edge 519 of the glass substrate 502 toward the multiplexing device 521.

In some alternative embodiments of the device 500, instead of the pocket 511 etched into the glass substrate 502 as shown in FIG. 5A, an FAU 564 can be actively optically coupled with a second side edge 516 of the glass substrate 502, or diced facet, of the glass substrate 502 as depicted in FIG. 5B. The FAU 564 can be arranged so that one or more fibers 566 thereof can be aligned with the waveguide 517 of the glass substrate 502, e.g., in an edge coupled arrangement.

In some assembly implementations of the device 500, the waveguide 517 and multiplexing device 521 can be written post-PIC and post-EIC attachment to the glass substrate 502 using a femtosecond laser writing technique aided by precise alignment marks on the PIC 522 and the glass substrate 502. Such a technique can facilitate precise alignment of the waveguide 517, multiplexing device 521, and the spot size convertor 562. With the PIC 522 hybrid bonded to the glass substrate 502, the waveguide 517 and multiplexing device 521 can be written to the glass substrate 502 to precisely align with the spot size convertor 562.

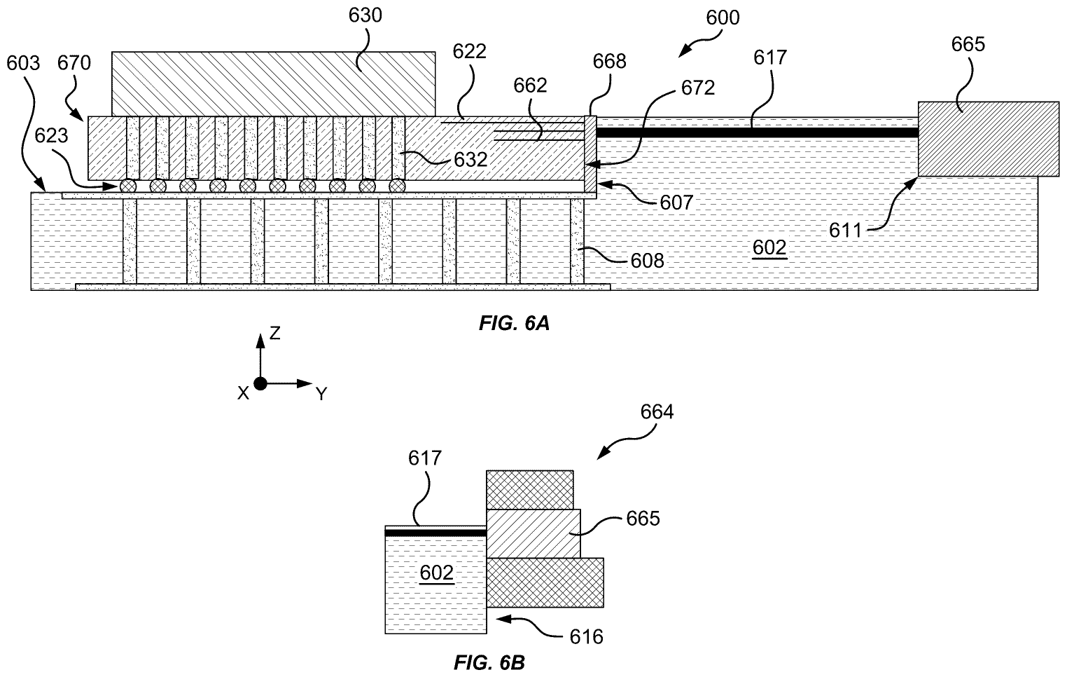

FIG. 6A is a schematic side view of a device 600 according to yet another example embodiment of the present disclosure. The device 600 of FIG. 6A includes some similar features as the device 100 of FIG. 1A and of the device 400 of FIG. 4A. Accordingly, similar numerals will be utilized to refer to like structures, except that 600 series numbers will be utilized to describe the device 600 of FIG. 6A.

The device 600 of FIG. 6A is constructed in a similar manner as the device 400 of FIG. 4A, except as provided below. As shown, for the example embodiment of FIG. 6A, the device 600 includes a glass substrate 602 having a plurality of TGVs 608 and a waveguide 617, a PIC 622 having a plurality of TSVs 632 and a spot size convertor 662, an EIC 630 stacked on the PIC 622, and a fiber 665 passively optically coupled with the glass substrate 602. The fiber 665 can be received and supported by a pocket 611 defined by the glass substrate 602. An index matching epoxy 668 can be arranged between an optical edge 607 of the glass substrate 602 and a second side edge 672 (which is opposite a first side edge 670) of the PIC 622. In this example embodiment, the PIC 622 is “flip chip” attached to a platform seat 603 of the glass substrate 602, e.g., by way of solder balls 623 using hot air reflow. The EIC 630 can be coupled with the PIC 622 by way a hybrid bond or other suitable techniques.

In some assembly implementations of the device 600, the waveguide 617 can be written post-PIC and post-EIC attachment to the glass substrate 602 using a femtosecond laser writing technique aided by precise alignment marks on the PIC 622 and the glass substrate 602. Such a technique can facilitate precise alignment of the waveguide 617 and the spot size convertor 662. With the PIC 622 hybrid bonded to the glass substrate 602, the waveguide 617 can be written to the glass substrate 602 to precisely align with the spot size convertor 662.

In some alternative embodiments of the device 600, instead of the pocket 611 etched into the glass substrate 602 as shown in FIG. 6A, an FAU 664 can be actively optically coupled with a second side edge 616 of the glass substrate 602, or diced facet, of the glass substrate 602 as depicted in FIG. 6B. The FAU 664 can be arranged so that one or more fibers 665 thereof can be aligned with the waveguide 617 of the glass substrate 602, e.g., in an edge coupled arrangement.

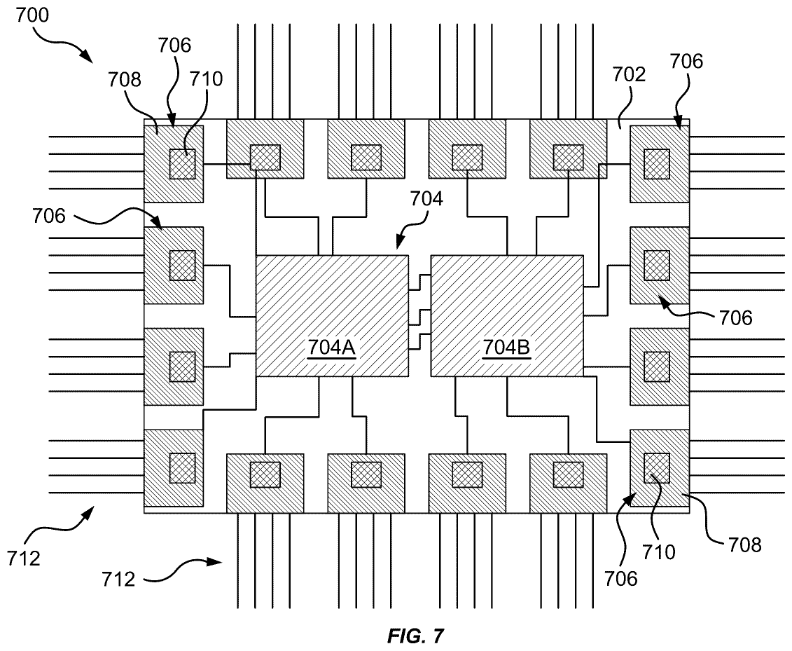

FIG. 7 is a schematic top plan view of an apparatus 700 according to one example embodiment of the present disclosure. The apparatus 700 of FIG. 7 has a common glass substrate to which one or more Integrated Circuits (ICs) and optical engines can be coupled, e.g., by respective metal-to-metal, oxide-to-oxide hybrid bonds. The apparatus 700 can be used for CPO and/or AI applications, for example.

As shown in FIG. 7, the apparatus 700 includes a glass substrate 702. The glass substrate 702 can be arranged in a same or similar manner as the glass substrate 102 of the device 100 of FIG. 1A. In this regard, the glass substrate 702 can include metallization, top and bottom RDLs, and a plurality of TGVs. The glass substrate 702 can be arranged on a PCB, for example. The apparatus 700 also includes one or more ICs 704, which can each be coupled with the glass substrate 702. For the depicted embodiment of FIG. 7, the ICs 704 include a first IC 704A and a second IC 704B, which can be respectively hybrid bonded to the glass substrate 702, e.g., by way of metal-to-metal, oxide-to-oxide hybrid bonds. The ICs 704 can be, for example, Application-Specific Integrated Circuits (ASICs), such as Network Processing Units (NPU)), Graphics Processing Units (GPU), Central Processing Units (CPU), Field Programmable Gate Arrays (FPGA), some combination thereof, etc. The ICs 704 can be electrically coupled with one another as shown in FIG. 7.

Further, the apparatus 700 can include at least one device having a PIC and an EIC, or rather, at least one optical engine arranged for photoelectric signal conversion. For the depicted embodiment of FIG. 7, the apparatus 700 includes a plurality of devices 706 arranged as optical engines that are positioned along a perimeter of the glass substrate 702. Each device 706 includes a PIC 708 and an EIC 710 coupled thereto. The PIC 708 of each one of the devices 706 has TSVs and is hybrid bonded to the glass substrate 702, e.g., by way of a metal-to-metal, oxide-to-oxide hybrid bond. For instance, the PICs 708 of the devices 706 can be arranged in a same or similar manner as the PIC 122 of the device 100 of FIG. 1A. The EICs 710 can be hybrid bonded to their respective PICs 708 or can be attached in other suitable manners disclosed herein. In some embodiments, a light source can be coupled with each one of the PICs 708. Each one of the devices 706, or optical engines, can be electrically coupled with one or both of the first and second ICs 704A, 704B, e.g., by way of electrically conductive pathways written into or on the glass substrate 702. As further illustrated in FIG. 7, fibers 712 can be coupled with each one of the devices 706, or rather, spot size convertors of the PICs 708 thereof. Optical signals can be routed to the respective devices 706 by way of the fibers 712, converted to electrical signals by the devices 706, and electrical signals can be routed to the ICs 704 and/or to other ones of the devices 706. In the opposite travel direction, electrical signals can be routed from the ICs 704 to the devices 706, converted by the devices 706 to optical signals, and routed to the fibers 712 to be carried offboard.

Accordingly, the apparatus 700 can be an electro-optical apparatus utilizing a common glass substrate to which one or more ICs and one or more optical engines can be coupled thereto, e.g., by way of metal-to-metal, oxide-to-oxide hybrid bonding. Electrically conductive pathways can be written to the common glass substrate to provide electrical coupling between the ICs and the optical engines. Such an apparatus can be useful for various applications, including CPO and/or AI applications.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

In view of the foregoing, the scope of the present disclosure is determined by the claims that follow.

We claim:

1. A device, comprising:
a glass substrate having a plurality of through-glass vias (TGVs);
a photonic integrated circuit (PIC) hybrid bonded to the glass substrate by way of a metal-to-metal, oxide-to-oxide hybrid bond, the PIC having a plurality of through-silicon vias (TSVs) that are coupled with the TGVs; and
an electronic integrated circuit (EIC) coupled with the PIC.

2. The device of claim 1, wherein an edge of the PIC that provides an optical coupling interface is coplanar with a side edge of the glass substrate.

3. The device of claim 1, wherein a thickness of the PIC is 120 microns or less.

4. The device of claim 1, wherein the EIC is coupled with the PIC by way of a metal-to-metal, oxide-to-oxide hybrid bond, a thermocompression bond, a copper pillar flip chip process, or a microbump flip chip process.

5. The device of claim 4, wherein the PIC has a substrate-interface surface and a stackable-interface surface defining a thickness of the PIC, and wherein the PIC has a metal via connected to a metal pad at the stackable-interface surface.

6. The device of claim 5, wherein a contact surface of the metal pad is flush with the stackable-interface surface of the PIC.

7. The device of claim 1, further comprising:
a second chip hybrid bonded or flip chipped attached to the glass substrate.

8. The device of claim 1, wherein the PIC and the EIC form an optical engine that is one of a plurality of optical engines coupled with the glass substrate, and wherein one or more integrated circuits are coupled with the glass substrate and with the plurality of optical engines.

9. The device of claim 1, further comprising:
a fiber coupled with the glass substrate,
wherein the glass substrate defines a platform pocket in which the PIC is arranged, and wherein the glass substrate has a waveguide arranged to match with the fiber coupled with the glass substrate, the waveguide couples the fiber with a spot size convertor of the PIC.

10. The device of claim 9, wherein the glass substrate defines a pocket in which the fiber is arranged, and wherein the fiber is passively optically coupled with the waveguide.

11. The device of claim 9, wherein the fiber is actively optically coupled with the waveguide at a diced facet of the glass substrate by way of a fiber array unit.

12. The device of claim 1, further comprising:
a fiber coupled with the glass substrate,
wherein the glass substrate includes a multiplexing device embedded therein, and wherein the multiplexing device is coupled with the fiber by way of a waveguide of the glass substrate.

13. The device of claim 1, further comprising:
a fiber coupled with the glass substrate,
wherein the glass substrate has a first side edge and a second side edge defining a length of the glass substrate, and wherein the glass substrate has a first section and a second section, the first section extends from the first side edge to an optical edge defining, at least in part, a platform pocket in which the PIC is arranged, and the second section extends between the optical edge and the second side edge, and
wherein the TGVs are arranged in the first section and a waveguide embedded within the glass substrate extends from the optical edge to the fiber.

14. The device of claim 13, wherein the second section is thicker than the first section.

15. The device of claim 1, wherein the PIC has a substrate-interface surface and a stackable-interface surface defining a thickness of the PIC, and wherein at least one TSV of the plurality of TSVs extends through a silicon handle of the PIC and is flush with the substrate-interface surface.

16. A method, comprising:
hybrid bonding a plurality of photonic integrated circuits (PICs) to a glass substrate wafer, the plurality of PICs each having through-silicon vias (TSVs) and the glass substrate wafer having a plurality of through-glass vias (TGVs) coupled with the TSVs of the plurality of PICs when the PICs are hybrid bonded to the glass substrate wafer;
attaching a plurality of electronic integrated circuits (EICs) to respective ones of the plurality of PICs;
attaching a plurality of light sources to respective ones of the plurality of PICs; and
performing wafer singulation to create respective electro-optical packages, with each electro-optical package including a glass substrate separated from the glass substrate wafer, at least one of the plurality of PICs, at least one of the plurality of EICs, and at least one of the plurality of light sources,
wherein, in performing the wafer singulation, at least one electro-optical package of the electro-optical packages is diced through the glass substrate and a PIC of the at least one electro-optical package to create an optical interface of the PIC that is coplanar with a diced edge of the glass substrate.

17. The method of claim 16, wherein in performing the wafer singulation, at least two electro-optical packages of the electro-optical packages are diced through the glass substrates and the PICs of the at least two electro-optical packages concurrently.

18. The method of claim 16, further comprising:
performing, prior to wafer singulation, a wafer level test using a test card to test which ones of the electro-optical packages satisfy an operational threshold.

19. The method of claim 16, further comprising:
coupling a fiber array unit to the optical interface of the PIC.

20. An apparatus, comprising:
a glass substrate having a plurality of through-glass vias (TGVs);
an integrated circuit (IC) connected to the glass substrate; and
at least one device coupled with the IC, the device comprising:
a photonic integrated circuit (PIC) hybrid bonded to the glass substrate and having a plurality of through-silicon vias (TSVs) coupled with the TGVs; and
an EIC coupled with the PIC.
